(19) United States
(12) Patent Application Publication
(10) Pub. No.: US 2007/0211422 A1
(43) Pub. Date: Sep. 13, 2007

(54) Removable hard disk housing assembly

(76) Inventors: Kuo-Kuang Liu, Caotun Township (TW); Yu-Chen Chu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/368,492

(22) Filed: Mar. 7, 2006

(51) Int. Cl. G06F 1/16

(52) U.S. Cl. 361/685

(57) ABSTRACT

The removable hard disk housing assembly includes a housing base, a hard disk bracket connected to a rear side of the housing base for carrying a hard disk, a securing handle pivotably mounted to a front side of the housing base, a locking hook pivotably mounted to the securing handle and a restoring spring. The locking hook has a hooking portion and is rotatable along a longitudinal direction relative to the securing handle. The hooking portion is selectively engaged in or departed from the engaging opening of the housing base. The restoring spring is disposed between the securing handle and the locking hook to provide a restoring force to the locking hook. Therefore, the hard disk housing assembly is prevented from falling off when it is subjected to an external force, and the locking hook is located along a longitudinal direction to increase a heat-dissipating space.

### BACKGROUND OF THE INVENTION

1. Field of the Invention

The present invention relates to a removable hard disk housing assembly, and in particular to a hard disk housing assembly that is suitable for desktop computers, servers and storage servers and is easily removable.

2. Description of Related Art

Electronic appliances such as conventional desktop computers, servers and storage servers usually include hard disks used to store required data. The hard disk is usually installed in a hard disk tray of the electronic appliance.

However, the conventional hard disk tray lacks an effective securing mechanism, so that the hard disk tray easily falls off if it is subjected to an external impact during transportation, thereby damaging the hard disk.

A conventional removable hard disk housing (hard disk tray) usually has a front bezel. The front bezel usually has a rotatable handle mounted at a front side thereof. The handle has a hook which is movable for hooking a pin of the bezel. Thus, the handle is secured in a locked state, and it also touches a power switch.

However, the hook of the conventional removable hard disk housing is usually mounted on the handle in a transverse action mode. Although the structure is simple, the transverse action mode of the hook, i.e. the hook moves left and right, occupies quite a large amount of the heat-dissipating space. Therefore, the air convection of heat-dissipating holes on the front bezel is affected.

Accordingly, the present invention aims to propose a removable hard disk housing that solves the above-mentioned problems in the prior art.

### SUMMARY OF THE INVENTION

It is an object of the present invention to provide a removable hard disk housing assembly, which adapts a screwless design for securing the removable hard disk housing assembly in a chassis without requiring the use of tools, and is easily assembled. It prevents the hard disk housing assembly from falling off when the hard disk housing assembly is subjected to an external force. The present invention adapts a longitudinal action mode to mount a locking hook therein for increasing heat-dissipating space, and has a stable, simple structure.

To achieve the object, the present invention provides a removable hard disk housing assembly, which is received in a hard disk chassis along a longitudinal direction and comprises a housing base, a hard disk bracket, a securing handle, a locking hook and a restoring spring. The housing base forms an engaging opening. The hard disk bracket is connected to a rear side of the housing base for carrying a hard disk. The securing handle is pivotably mounted at a front side of the housing base. The locking hook has a trigger portion and a hooking portion. The locking hook is pivotably mounted to the securing handle. The hooking portion is rotatable along a longitudinal direction related to the securing handle. The hooking portion of the locking hook is selectively engaged in or departed from the engaging opening of the housing base. The restoring spring is disposed between the securing handle and the locking hook.

### BRIEF DESCRIPTION OF THE DRAWINGS

The present invention can be fully understood from the following detailed description and preferred embodiment with reference to the accompanying drawings, in which:

FIG. 1 is an exploded perspective view of a removable hard disk housing assembly according to the present invention;

FIG. 2 is a perspective view of a removable hard disk housing assembly according to the present invention;

FIG. 3 is a perspective view of a removable hard disk housing assembly with a securing handle being in an open state according to the present invention;

FIG. 4A is a front view of a locking hook in an engaging state according to the present invention;

FIG. 4B is a cross-sectional side view of a locking hook in an engaging state according to the present invention;

FIG. 5A is a front view of a locking hook in a disengaging state according to the present invention;

FIG. 5B is a cross-sectional side view of a locking hook in a disengaging state according to the present invention;

FIG. 6 is a schematic view of a hard disk housing assembly being pushed into a hard disk chassis according to the present invention;

FIG. 7 is a cross-sectional view of a hard disk housing assembly assembled in a hard disk chassis according to the present invention;

FIG. 8 is a cross-sectional view of a hard disk housing assembly assembled in a hard disk chassis in a second position according to the present invention; and

FIG. 9 is a cross-sectional view of a hard disk housing assembly assembled in a hard disk chassis in a third position according to the present invention.

### DETAILED DESCRIPTION OF THE PREFERRED EMBODIMENTS

The following detailed description is of the best presently contemplated modes of carrying out the invention. This description is not to be taken in a limiting sense, and is made merely for the purpose of illustrating general principles of embodiments of the invention. The scope of the invention is best defined by the appended claims.

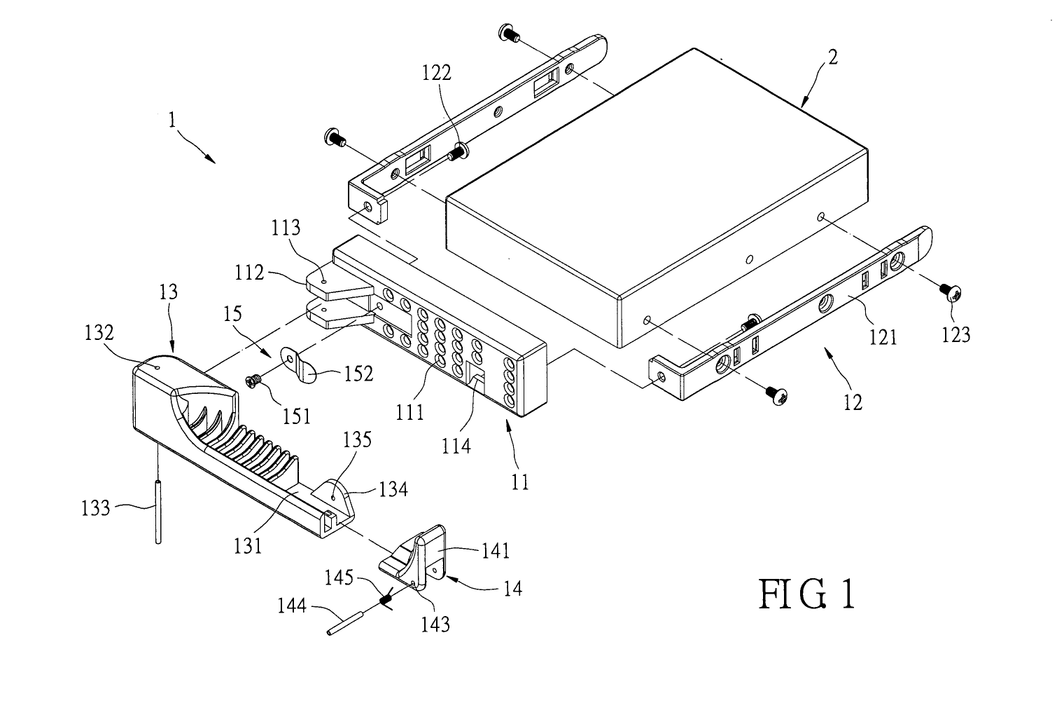

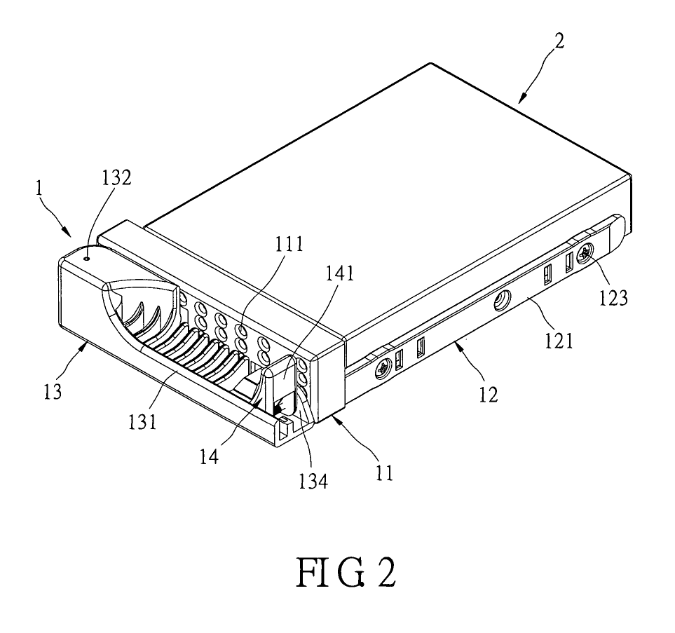

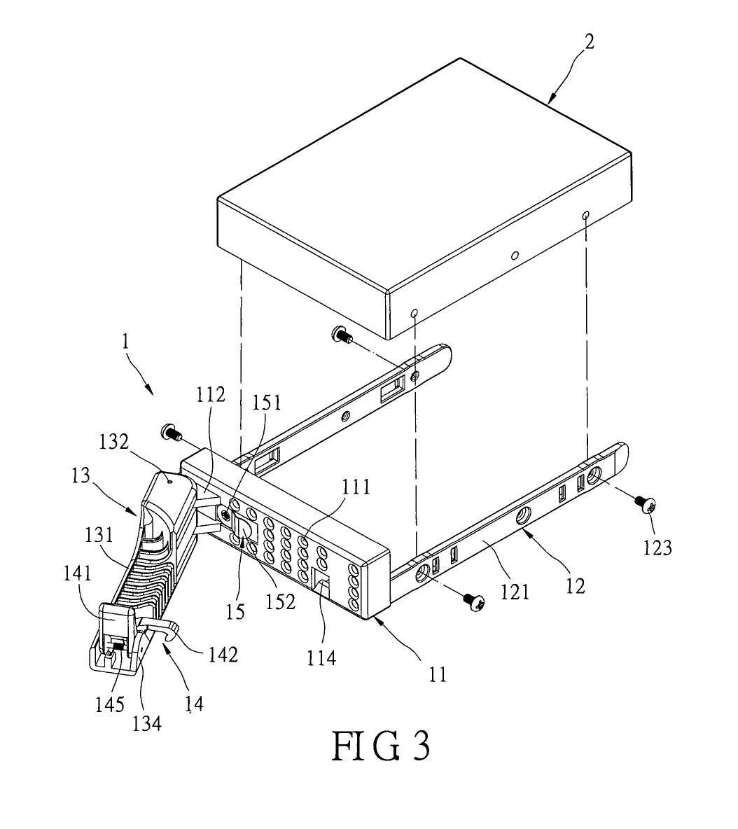

Reference is made to FIGS. 1-3. The present invention provides a hard disk housing assembly. The hard disk housing assembly 1 is used for receiving a hard disk 2, so that the hard disk 2 can be assembled into an electronic appliance. The hard disk housing assembly 1 comprises a housing base 11, a hard disk bracket 12, a securing handle 13, a locking hook 14 and a spring leaf 15. The housing base 11 is substantially rectangular-cubic shaped. The housing base 11 forms a plurality of heat-dissipating holes 111 thereon. The heat-dissipating holes 111 penetrate through from the front side to the rear side of the housing base 11, so that it can provide air convection and assist in removing heat from the hard disk 2. The housing base 11 has a first pivotal mount 112 protruded forwardly from one end thereof. The first pivotal mount 112 forms a first pivotal hole 113 along a vertical direction. The first pivotal hole 113 is pivotably mounted with the securing handle 13. The housing base 11 has an engaging opening 114 formed adjacent to one end of the front side thereof, so that the locking hook 14 can be engaged with the housing base 11.

The hard disk bracket 12 is disposed behind the housing base 11 for carrying and fixing the hard disk 2. In this embodiment, the hard disk bracket 12 comprises a pair of side racks 121. The pair of side racks 121 are symmetrical L-shaped frames. But the hard disk bracket 12 is not limited to such structure. Each of the side racks 121 has a front end that is connected respectively to two ends of a rear side of the housing base 11 by a connecting component (such as screw) 122, so that the hard disk bracket 12 is connected to the housing base 11. The hard disk 2 is received between the pair of side racks 121, and is fixed to the side racks 121 by a plurality of fixing components (such as screws) 123. Therefore, the hard disk 2 can be fixed in the hard disk housing assembly 1.

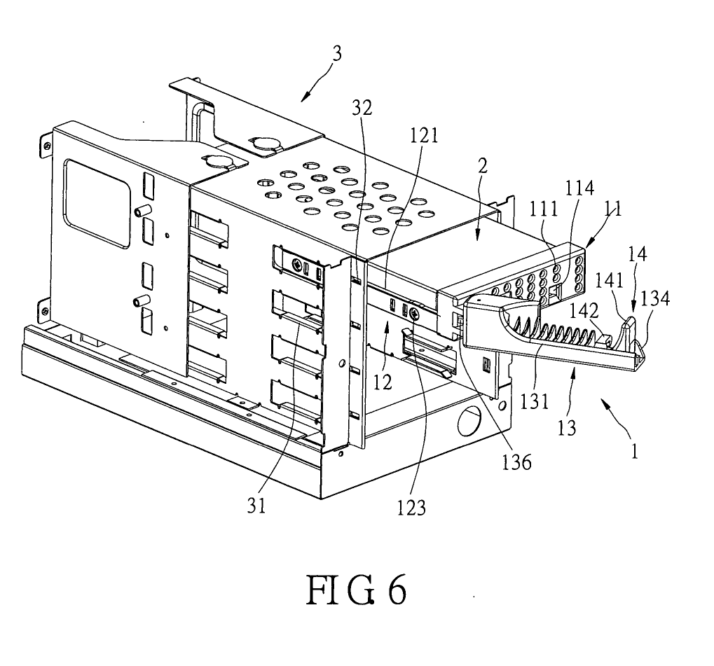

The securing handle 13 is disposed before the housing base 11. The securing handle 13 forms a concaved portion 131 corresponding to the heat-dissipating holes 111, so that the securing handle 13 cannot cover the heat-dissipating holes 111 and it is beneficial for air convection. The securing handle 13 has a second pivotal hole 132 formed adjacent to one end thereof along a vertical direction and a handle pin 133 inserted into the first pivotal hole 113 of the housing base and the second pivotal hole 132 of the securing handle 13. Therefore, the securing handle 13 is pivotably mounted to a front side of the housing base 11 by the vertical handle pin 133. The securing handle 13 has a second pivot mount 134 formed at another end thereof. The second pivot mount 134 forms a third pivot hole 135 along a longitudinal direction, so that the second pivot mount 134 can be pivotably mounted to the locking hook 14. The securing handle 13 has a protrusive latch 136 protruded from one end thereof (as shown in FIG. 6). The hard disk chassis 3 forms a locking aperture 32 corresponding to the protrusive latch 136.

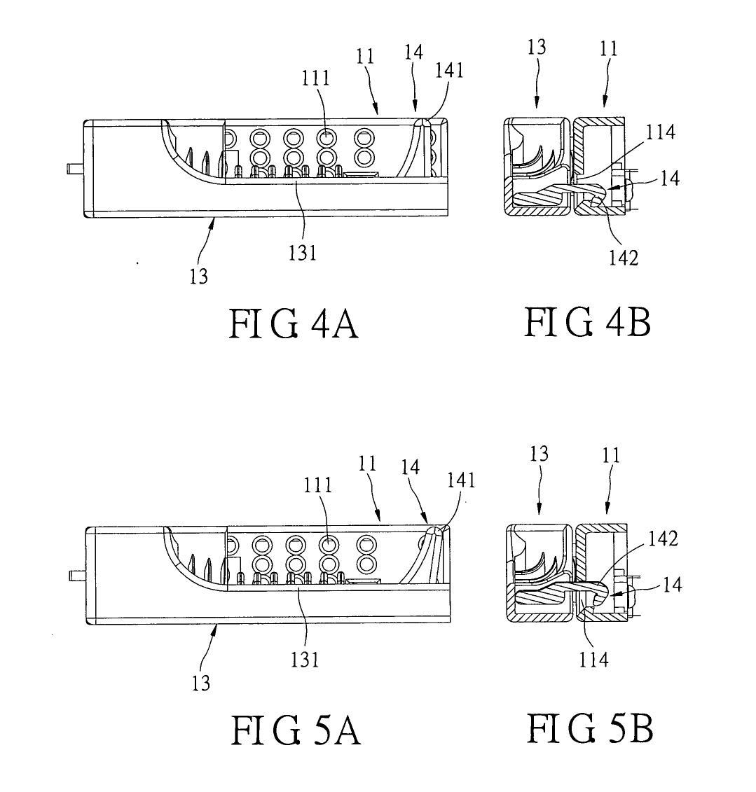

The locking hook 14 has a trigger portion 141 and a hooking portion 142. The trigger portion 141 is protruded upwardly from one side thereof, which is conveniently for a finger to push. The hooking portion 142 is connected with the trigger portion 141. The hooking portion 142 is hook-shaped and extends rearward in a protrusive way, so that it can engage with the engaging opening 114 to each other. The locking hook 14 further comprises a fourth pivotal hole 143 along a longitudinal direction and a hook pin 144 inserted into the third pivot hole 135 of the securing handle 13 and the fourth pivotal hole 143 of the locking hook 14. The locking hook 14 is pivotably mounted to the securing handle 13 by the hook pin 144 in a longitudinal action mode, so that the hooking portion 142 can swing from up to down (along a longitudinal direction) relative to the securing handle 13. The hook pin 144 is sleeved in a restoring spring 145. Two ends of the restoring spring 145 are abutted against the securing handle 13 and the locking hook 14 respectively. The restoring spring 145 is located between the securing handle 13 and the locking hook 14 to provide a restoring force for the locking hook 14. When the trigger portion 141 is turned, the hooking portion 142 of the locking hook 14 is moved for engaging within or disengaging from the engaging opening 114 of the housing base 11. Therefore, the locking hook 14 can be in an engaging state (as shown in FIG. 4A and FIG. 4B) or a disengaging state (as shown in FIG. 5A and FIG. 5B) related to the housing base 11.

The spring leaf 15 is disposed at a front side of the housing base 11. The spring leaf 15 is penetrated and fixed to a front side of the housing base 11 by a fixing component (such as a screw) 151. The spring leaf 15 has an abutting portion 152 that is abutted against a rear side of the securing handle 13 elastically, so that the securing handle 13 is provided with an elastic force for springing toward and the securing handle 13 is used conveniently. The removal of the hard disk housing assembly of the present invention is accomplished through the above-mentioned structure.

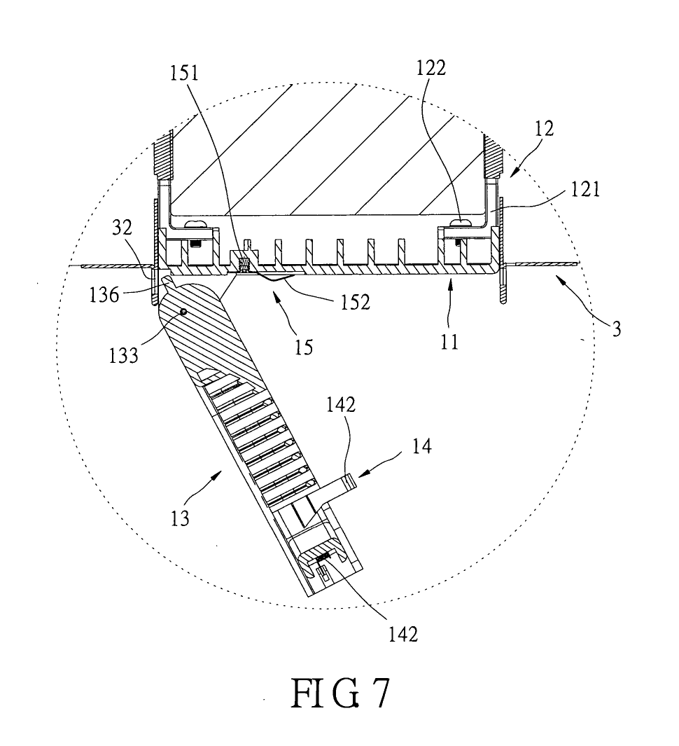

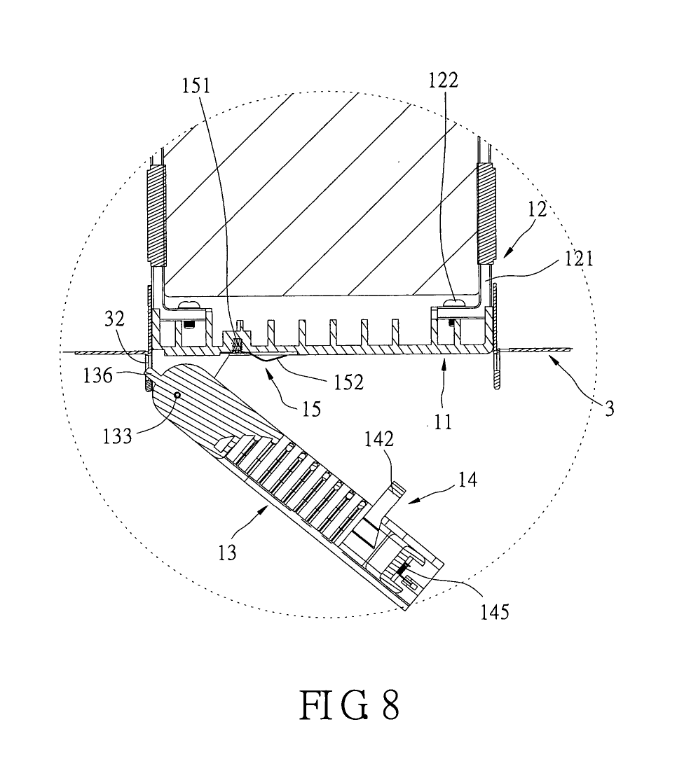

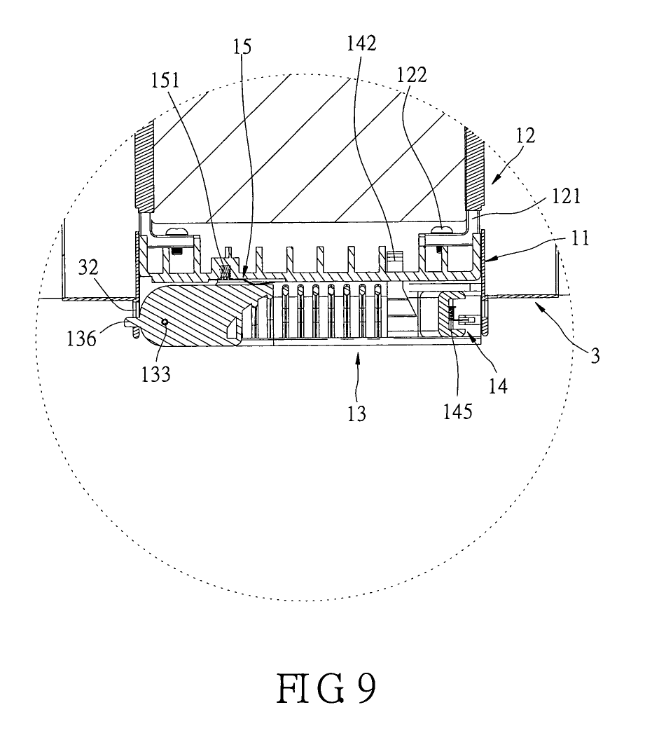

The hard disk housing assembly 1 of the present invention can be received in a hard disk chassis 3 of the electronic appliance, when it is pushed inward along a receiving cavity 31 of the hard disk chassis 3 (as shown in FIG. 6). The hard disk chassis 3 forms at least one locking aperture 32 at a front side thereof (as shown in FIG. 8). When the hard disk housing assembly 1 is pushed to an predetermined inside position of the hard disk chassis 3 (as shown in FIG. 7) and the securing handle 13 is pushed inward, the protrusive latch 136 formed at one end of the securing handle 13 is rotated into the corresponding locking aperture 32 of the hard disk chassis 3 (as shown in FIG. 8) and a torque is produced to move the hard disk housing assembly 1 to a fixing position. After the securing handle 13 is pushed inwardly to an end, the hooking portion 142 of the locking hook 14 is restored and engaged with the engaging opening 114 of the housing base 11. Therefore, the locking hook 14 and the housing base 11 is in the engaging state (as shown in FIG. 9), and allows the hard disk 2 to be fixed in place.

The hard disk housing assembly 1 of the present invention provides a screwless design to fix in the hard disk chassis without requiring the use of tools, and it is easily assembled. It also provides the locking hook 14 and the housing base 11 for engaging to each other and provides the function for fixing the hard disk 2, which prevents the hard disk housing assembly 1 from falling off when it is subjected to an external force.

In addition, the present invention provides a stable, simple structure, and the locking hook 14 is pivotably mounted to the securing handle 13 by the hook pin 144 along a longitudinal direction. The locking hook 14 is mounted in a longitudinal action mode, i.e. the locking hook 14 moves from up to down and the heat-dissipating space is increased.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A removable hard drive housing assembly, being received in a hard disk chassis along a longitudinal direction, comprising:
a housing base, forming an engaging opening;
a hard disk bracket, connecting to a rear side of said housing base for carrying a hard disk;
a securing handle, pivotably mounted at a front side of said housing base;
a locking hook, having a trigger portion and a hooking portion, said locking hook pivotably mounted to said securing handle, said hooking portion being rotatable along a longitudinal direction relative to said securing handle, thereby said hooking portion of said locking hook being selectively engaged in or departed from said engaging opening of said housing base; and
a restoring spring, disposed between said securing handle and said locking hook.

2. The removable hard drive housing assembly as in claim 1, wherein said housing base forms a plurality of heat-dissipating holes, said heat-dissipating holes penetrate through front and rear sides of said housing base, said securing handle forms a concaved portion corresponding to said heat-dissipating holes.

3. The removable hard drive housing assembly as in claim 1, wherein said housing base has a first pivotal mount formed at a front side thereof, said first pivotal mount forms a first pivotal hole therein, said securing handle has a second pivotal hole formed therein and a handle pin inserted in said first pivotal hole and said second pivotal hole, thereby said securing handle is pivotably mounted to a front side of said housing base.

4. The removable hard drive housing assembly as in claim 1, wherein said hard disk bracket comprises a pair of side racks, each said side racks has a front end respectively connected to two sides of a rear end of said housing base via connecting components, said hard disk is received between said side racks, said hard disk is fixed to said side racks via a fixing component.

5. The removable hard drive housing assembly as in claim 1, wherein said securing handle has a protrusive latch protruding from an end thereof, said hard disk chassis forms a locking aperture corresponding to said protrusive latch, said protrusive latch of said securing handle rotates into said locking aperture of said hard disk chassis when said hard disk housing assembly is pushed to a predetermined inside position of said hard disk chassis and said securing handle is pushed inwardly.

6. The removable hard drive housing assembly as in claim 1, wherein said securing handle has a second pivot mount formed at an end thereof, said second pivot mount forms a third pivot hole along a longitudinal direction, said locking hook has a fourth pivotal hole formed along a longitudinal direction and a hook pin inserted into said third pivot hole and said fourth pivotal hole, thereby said locking hook is pivotably mounted to said securing handle.

7. The removable hard drive housing assembly as in claim 1, wherein said housing base has a spring leaf disposed at a front side thereof, said spring leaf has an abutting portion that is elastically abutted against a rear side of said securing handle.

8. The removable hard drive housing assembly as in claim 7, wherein said spring leaf is fixed to said housing base via a fixing component.
